(19) United States
(12) Patent Application Publication
(10) Pub. No.: US 2024/0155577 A1
(43) Pub. Date: May 9, 2024

(54) ADDITIONAL GUARD RESOURCE ELEMENTS IN A FREQUENCY DOMAIN

(71) Applicant: QUALCOMM Incorporated, San Diego, CA (US)

(72) Inventors: Qiaoyu LI, Beijing (CN); Hao XU, Beijing (CN); Qiang WU, San Diego, CA (US)

(21) Appl. No.: 18/279,537

(22) PCT Filed: May 27, 2021
(86) PCT No.: PCT/CN2021/096257

§ 371 Date: Aug. 30, 2023

(51) Int. Cl. H04W 72/0453; H04L 5/00; H04L 27/26; H04W 72/232

(52) U.S. Cl. CPC H04W 72/0453; H04L 5/0051; H04L 27/2605; H04W 72/232

(57) ABSTRACT

Various aspects of the present disclosure generally relate to wireless communication. In some aspects, a user equipment (UE) may receive, from a base station, a configuration that defines a quantity of additional guard resource elements (REs) in a frequency domain between different frequency division multiplexed demodulation reference signal (DMRS) code division multiplexing (CDM) groups. The additional guard REs in the frequency domain may not be associated with signal transmissions. The UE may perform a channel estimation based at least in part on the quantity of additional guard REs in the frequency domain between the different frequency division multiplexed DMRS CDM groups. Numerous other aspects are described.

### FIELD OF THE DISCLOSURE

Aspects of the present disclosure generally relate to wireless communication and to techniques and apparatuses for additional guard resource elements (REs) in a frequency domain.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory and one or more processors, coupled to the memory, configured to: receive, from a base station, a configuration that defines a quantity of additional guard resource elements (REs) in a frequency domain between different frequency division multiplexed demodulation reference signal (DMRS) code division multiplexing (CDM) groups, wherein the additional guard REs in the frequency domain are not associated with signal transmissions; and perform a channel estimation based at least in part on the quantity of additional guard REs in the frequency domain between the different frequency division multiplexed DMRS CDM groups.

In some aspects, a base station for wireless communication includes a memory and one or more processors, coupled to the memory, configured to: transmit, to a UE, a configuration that defines a quantity of additional guard REs in a frequency domain between different frequency division multiplexed DMRS CDM groups, wherein the additional guard REs in the frequency domain are not associated with signal transmissions; and transmit, to the UE, one or more DMRS symbols, wherein the one or more DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups.

In some aspects, a method of wireless communication performed by a UE includes receiving, from a base station, a configuration that defines a quantity of additional guard REs in a frequency domain between different frequency division multiplexed DMRS CDM groups, wherein the additional guard REs in the frequency domain are not associated with signal transmissions; and performing a channel estimation based at least in part on the quantity of additional guard REs in the frequency domain between the different frequency division multiplexed DMRS CDM groups.

In some aspects, a method of wireless communication performed by a base station includes transmitting, to a UE, a configuration that defines a quantity of additional guard REs in a frequency domain between different frequency division multiplexed DMRS CDM groups, wherein the additional guard REs in the frequency domain are not associated with signal transmissions; and transmitting, to the UE, one or more DMRS symbols, wherein the one or more DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups.

In some aspects, a non-transitory computer-readable medium storing a set of instructions for wireless communication includes one or more instructions that, when executed by one or more processors of a UE, cause the UE to: receive, from a base station, a configuration that defines a quantity of additional guard REs in a frequency domain between different frequency division multiplexed DMRS CDM groups, wherein the additional guard REs in the frequency domain are not associated with signal transmissions; and perform a channel estimation based at least in part on the quantity of additional guard REs in the frequency domain between the different frequency division multiplexed DMRS CDM groups.

In some aspects, a non-transitory computer-readable medium storing a set of instructions for wireless communication includes one or more instructions that, when executed by one or more processors of a base station, cause the base station to: transmit, to a UE, a configuration that defines a quantity of additional guard REs in a frequency domain between different frequency division multiplexed DMRS CDM groups, wherein the additional guard REs in the frequency domain are not associated with signal transmissions; and transmit, to the UE, one or more DMRS symbols, wherein the one or more DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups.

In some aspects, an apparatus for wireless communication includes means for receiving, from a base station, a configuration that defines a quantity of additional guard REs in a frequency domain between different frequency division multiplexed DMRS CDM groups, wherein the additional guard REs in the frequency domain are not associated with signal transmissions; and means for performing a channel estimation based at least in part on the quantity of additional guard REs in the frequency domain between the different frequency division multiplexed DMRS CDM groups.

In some aspects, an apparatus for wireless communication includes means for transmitting, to a UE, a configuration that defines a quantity of additional guard REs in a frequency domain between different frequency division multiplexed DMRS CDM groups, wherein the additional guard REs in the frequency domain are not associated with signal transmissions; and means for transmitting, to the UE, one or more DMRS symbols, wherein the one or more DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of abase station in communication with a UE in a wireless network, in accordance with the present disclosure.

FIG. 3 is a diagram illustrating an example of air-to-ground communications, in accordance with the present disclosure.

FIGS. 4-5 are diagrams illustrating examples of DMRS configurations, in accordance with the present disclosure.

FIG. 6 is a diagram illustrating an example associated with additional guard REs between frequency division multiplexed DMRS CDM groups, in accordance with the present disclosure.

FIG. 7 is a diagram illustrating an example associated with additional guard REs in a frequency domain, in accordance with the present disclosure.

FIGS. 8-10 are diagrams illustrating examples associated with additional guard REs between frequency division multiplexed DMRS CDM groups, in accordance with the present disclosure.

FIG. 11 is a diagram illustrating an example associated with a staggered pattern of additional guard REs between frequency division multiplexed DMRS CDM groups, in accordance with the present disclosure.

FIG. 12 is a diagram illustrating an example associated with mapping available RE(s), in accordance with the present disclosure.

FIGS. 13-14 are diagrams illustrating example processes associated with additional guard REs in a frequency domain, in accordance with the present disclosure.

FIGS. 15-16 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

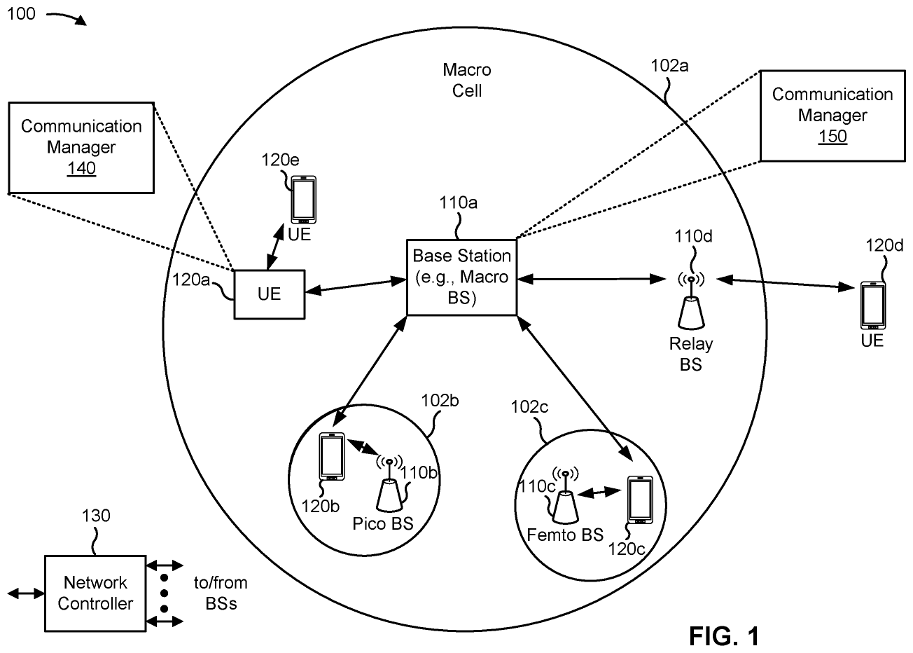

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smartjewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly. FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, a UE (e.g., UE 120) may include a communication manager 140. As described in more detail elsewhere herein, the communication manager 140 may receive, from a base station, a configuration that defines a quantity of additional guard REs in a frequency domain between different frequency division multiplexed DMRS CDM groups, wherein the additional guard REs in the frequency domain are not associated with signal transmissions; and perform a channel estimation based at least in part on the quantity of additional guard REs in the frequency domain between the different frequency division multiplexed DMRS CDM groups. Additionally, or alternatively, the communication manager 140 may perform one or more other operations described herein.

In some aspects, a base station (e.g., base station 110) may include a communication manager 150. As described in more detail elsewhere herein, the communication manager 150 may transmit, to a UE, a configuration that defines a quantity of additional guard REs in a frequency domain between different frequency division multiplexed DMRS CDM groups, wherein the additional guard REs in the frequency domain are not associated with signal transmissions; and transmit, to the UE, one or more DMRS symbols, wherein the one or more DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups. Additionally, or alternatively, the communication manager 150 may perform one or more other operations described herein.

As indicated above, FIG. 1 is provided as an example. Other examples may differ from what is described with regard to FIG. 1.

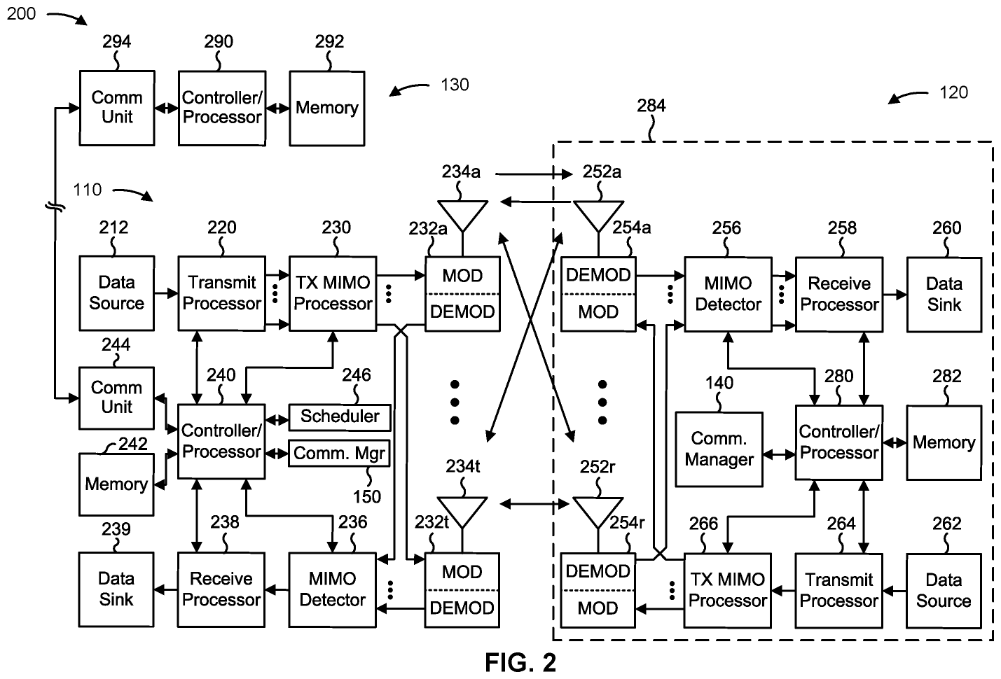

FIG. 2 is a diagram illustrating an example 200 of a base station 110 in communication with a UE 120 in a wireless network 100, in accordance with the present disclosure. Base station 110 may be equipped with T antennas 234a through 2341, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQTs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

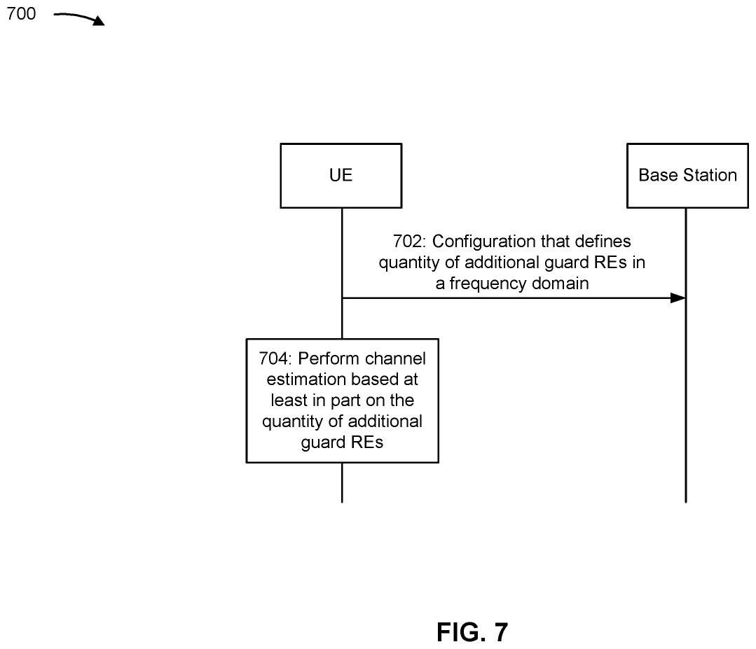

On the uplink, at UE 120, a transmit processor 264 may receive and process data from a data source 262 and control information (e.g., for reports that include RSRP. RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 7-14).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 7-14).

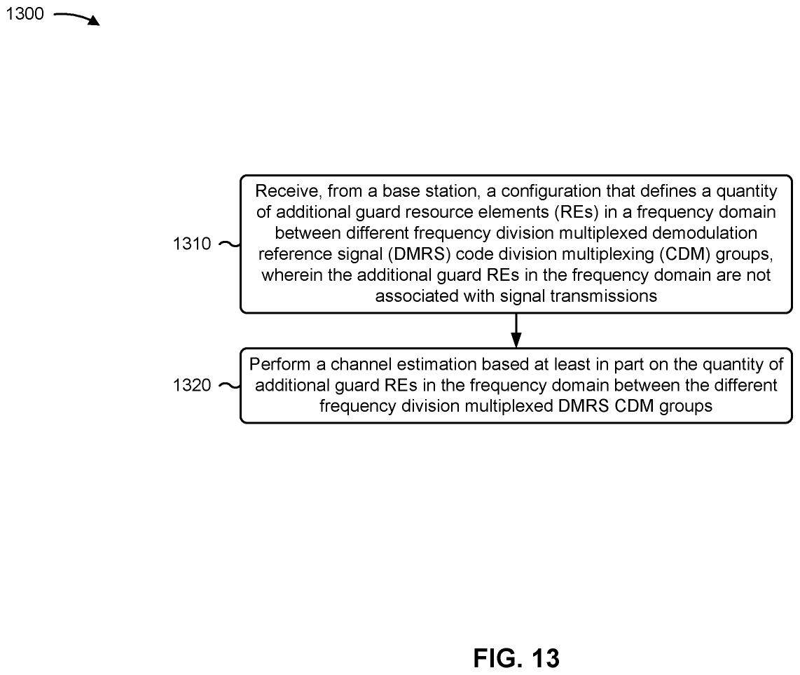

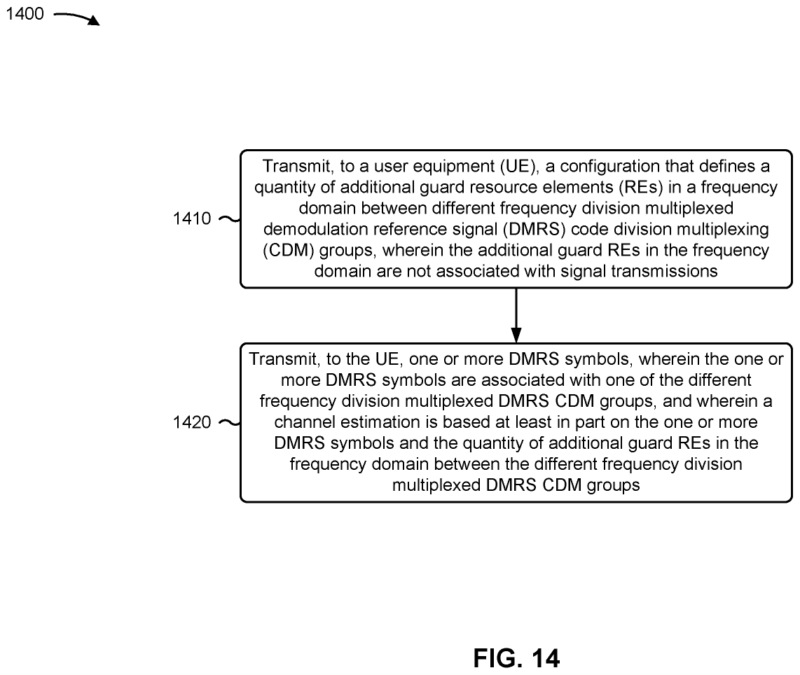

Controller/processor 240 of base station 110, controller/processor 280 of UE 120, and/or any other component(s) of FIG. 2 may perform one or more techniques associated with additional guard REs in a frequency domain, as described in more detail elsewhere herein. For example, controller/processor 240 of base station 110, controller/processor 280 of UE 120, and/or any other component(s) of FIG. 2 may perform or direct operations of, for example, process 1300 of FIG. 13, process 1400 of FIG. 14, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1300 of FIG. 13, process 1400 of FIG. 14, and/or other processes as described herein. In some aspects, executing instructions may include running the instructions, converting the instructions, compiling the instructions, and/or interpreting the instructions, among other examples.

In some aspects, a UE (e.g., UE 120) includes means for receiving, from a base station, a configuration that defines a quantity of additional guard REs in a frequency domain between different frequency division multiplexed DMRS CDM groups, wherein the additional guard REs in the frequency domain are not associated with signal transmissions; and/or means for performing a channel estimation based at least in part on the quantity of additional guard REs in the frequency domain between the different frequency division multiplexed DMRS CDM groups. The means for the UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a base station (e.g., base station 110) includes means for transmitting, to a UE, a configuration that defines a quantity of additional guard REs in a frequency domain between different frequency division multiplexed DMRS CDM groups, wherein the additional guard REs in the frequency domain are not associated with signal transmissions; and/or means for transmitting, to the UE, one or more DMRS symbols, wherein the one or mom DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups. The means for the base station to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above. FIG. 2 is provided as an example. Other examples may differ from what is described with regard to FIG. 2.

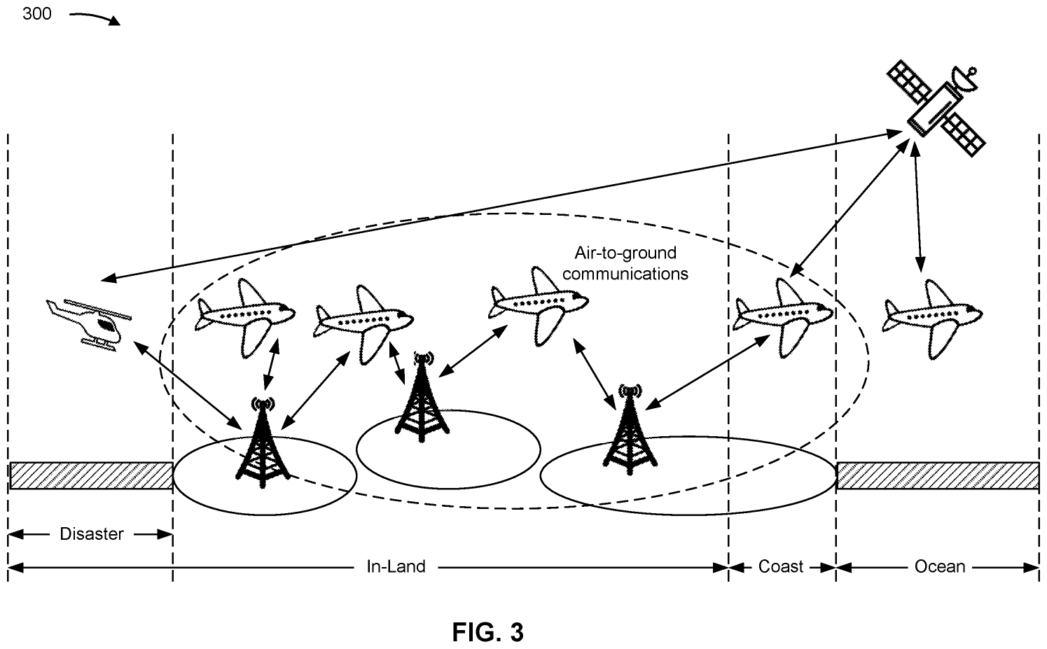

FIG. 3 is a diagram illustrating an example 300 of air-to-ground communications, in accordance with the present disclosure.

Air-to-ground communications may allow base stations on the ground to communicate with aircraft and UEs associated with the aircraft (e.g., UEs carried by passengers on the aircraft). Air-to-ground communications may support various traffic types, such as passenger communications, aircraft surveillance and maintenance, and/or air traffic control or airline operation communications. Air-to-ground communications may serve as a back-up to systems in aviation licensed bands. Air-to-ground communications may enable in-flight connectivity. An air-to-ground network may be deployed inland (e.g., which may include disaster areas) and/or in coastal areas. In the air-to-ground network, base stations on the ground may be associated with up-tilting antennas. Aircraft in the air may be associated with antennas that are located at an aircraft underside. UEs associated with the aircraft may be connected to the air-to-ground network via an onboard customer premise equipment (CPE) (e.g., in-cabin WiFi or small cell). Air-to-ground communications may provide various advantages over satellite communications, such as lower cost, higher throughput, and lower latency.

As indicated above, FIG. 3 is provided as an example. Other examples may differ from what is described with regard to FIG. 3.

Frequency division duplexing (FDD) may be employed for NR non-terrestrial networks (NTNs). Time division duplexing (TDD) may be employed for certain scenarios, such as high altitude platform stations (HAPS) and/or air-to-ground communications.

An air-to-ground network may be associated with a relatively large inter-site distance and a relatively large coverage area. In order to control a deployment cost of the air-to-ground network and considering a relatively low quantity of aircraft, a relatively large inter-site distance may be preferred (e.g., about 100 km to 200 km). “Inter-site distance” may refer to a distance between cells and/or base stations. When an aircraft is above the sea, a distance between the aircraft and a nearest base station may be more than 200 km and possibly up to 300 km. Therefore, the air-to-ground network may be designed to provide up to a 300 km cell coverage range. Further, the air-to-ground network may be designed to provide service for aircraft with relatively high flight speeds (e.g., up to 1200 km/hour).

Non-disjoint operator proprietary frequency ranges may be utilized for deploying both air-to-ground and terrestrial networks. Operators may adopt a same frequency range for deploying both air-to-ground and terrestrial networks, which may save a frequency resource cost. Interference between the air-to-ground and terrestrial networks may be mitigated using various interference mitigation techniques, which may enable coexistence between the air-to-ground and terrestrial networks. In a specific example, a 4.8 GHz frequency range may be deployed for both the air-to-ground and terrestrial networks.

An on-board air-to-ground terminal may be more powerful than a terrestrial UE. The on-board air-to-ground terminal may have a higher effective, or equivalent, isotropically radiated power (EIRP) via a larger transmission power and/or a larger on-board antenna gain with respect to the terrestrial UE.

An air-to-ground network may pose various design challenges. One challenge is that the air-to-ground network may be associated with a relatively large inter-site distance and a relatively large timing advance, which may avoid frequent handover and reduce inter-cell interference. The inter-site distance may be 100 to 200 km inland, and up to 300 km on the coasts. A timing advance may be up to 2 ms when the inter-site distance is 300 km. Another challenge is coexistence and interference with terrestrial UEs. A relatively wide terrestrial area may be affected due to a relatively long propagation, which may result in dynamic and non-synchronized interference. Another challenge is a relatively large required per-aircraft/cell throughput. For example, over 1.2 Gbps throughput may be required per aircraft and a maximum of 60 aircraft may be present per cell (including cell edges). Another challenge is a relatively large Doppler shift and a relatively large multipath delay. For example, when communicating in an L-band, an 8 μs or more multipath delay may occur when an aircraft is en route, and a 5 μs multipath delay may occur when the aircraft is climbing or descending. The relatively large multipath delay may require a relatively large cyclic prefix length. The Doppler shift may increase with a higher frequencies, and certain cases such as a multi-TRP configuration may involve additional design considerations. The relatively large Doppler shift and multipath delay may be associated with a relatively short coherence time and relatively fast timing advance drifting. Another challenge is various operation propagation scenarios. For example, an aircraft that is en route may be associated with a first set of Doppler shift and delay characteristics, while an aircraft that is climbing or descending may be associated with a second set of Doppler shift and delay characteristics.

Air-to-ground channel measurements may be based at least in part on whether the aircraft is en route, climbing/descending, taking off or landing, or taxiing/parking. The air-to-ground channel measurements may be associated with a given band. The air-to-ground channel measurements may be associated with a Rician distribution or a Rayleigh distribution, depending on whether the aircraft is en route, climbing/descending, taking off or landing, or taxiing/parking. As an example, air-to-ground channel measurements associated with an aircraft that is en route and is climbing or descending may be associated with mountain delay, a line-of-sight (LOS) Doppler shift dominance, and a relatively small Doppler shift. As another example, air-to-ground channel measurements associated with an aircraft that is taking off or landing may be associated with a hill/building delay, and a larger Doppler shift as compared to the aircraft that is en route and is climbing or descending.

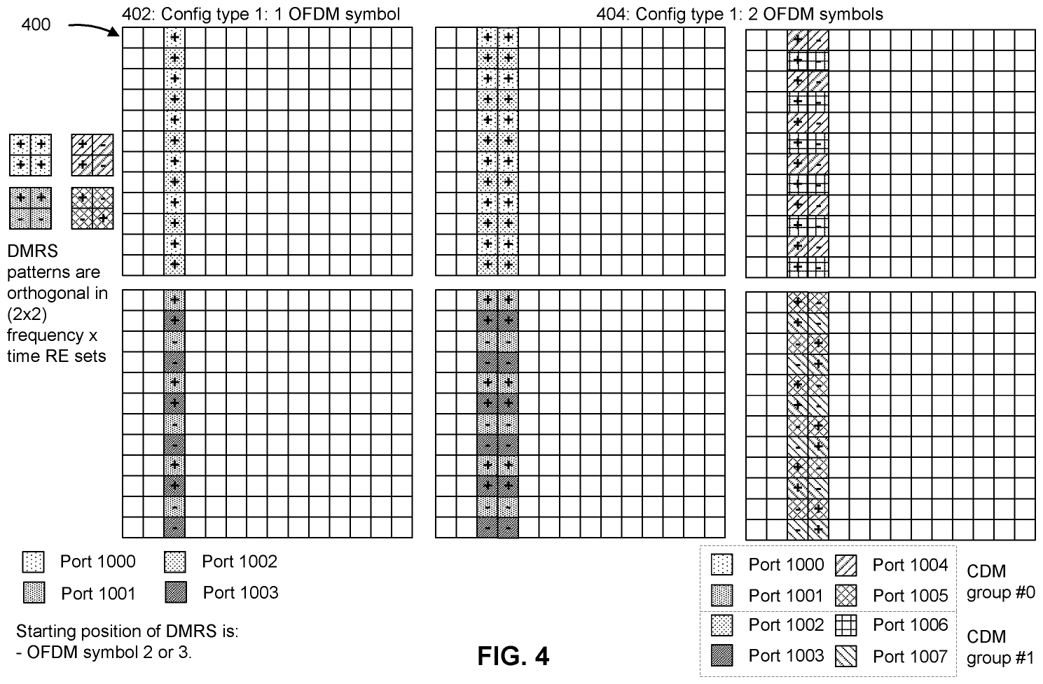

FIG. 4 is a diagram illustrating an example 400 of a DMRS configuration, in accordance with the present disclosure.

As shown by reference number 402, a DMRS configuration may be for a physical downlink shared channel (PDSCH) and may be associated with a configuration type-1. The DMRS configuration may be associated with one OFDM symbol. A starting position of a DMRS may be in OFDM symbol 2 or OFDM symbol 3. The DMRS may be associated with a port, such as port 1000, port 1001, port 1002, or port 1003.

As shown by reference number 404, a DMRS configuration may be for a PDSCH and may be associated with a configuration type-1. The DMRS configuration may be associated with two OFDM symbols. A starting position of a DMRS may be in OFDM symbol 2 or OFDM symbol 3. The DMRS configuration may be associated with DMRS patterns, which may be orthogonal in two-by-two (in frequency and time) resource element (RE) sets. The DMRS may be associated with a port, such as port 1000, port 1001, port 1002, port 1003, port 1004, port 1005, port 1006, or port 1007. Port 1000, port 1001, port 1004, and port 1005 may be associated with a first code division multiplexing (CDM) group (e.g., CDM group #0). Port 1002, port 1003, port 1006, and port 1007 may be associated with a second CDM group (e.g., CDM group #1).

As indicated above, FIG. 4 is provided as an example. Other examples may differ from what is described with regard to FIG. 4.

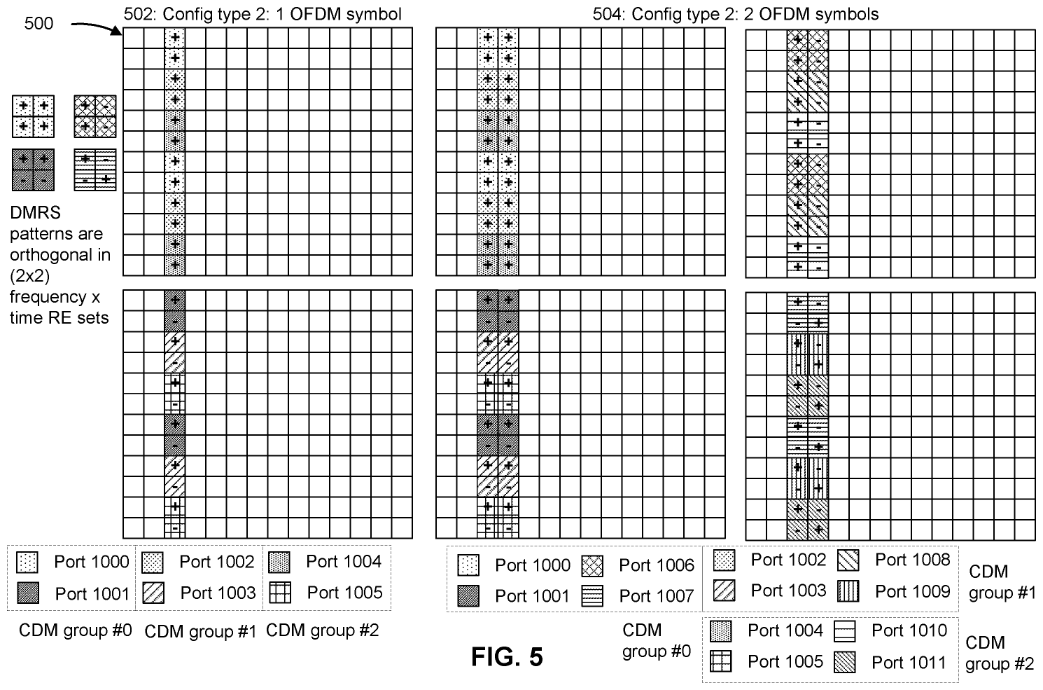

FIG. 5 is a diagram illustrating an example 500 of a DMRS configuration, in accordance with the present disclosure.

As shown by reference number 502, a DMRS configuration may be for a PDSCH and may be associated with a configuration type-2. The DMRS configuration may be associated with one OFDM symbol. A starting position of a DMRS may be in OFDM symbol 2 or OFDM symbol 3. The DMRS may be associated with a port, such as port 1000, port 1001, port 1002, port 1003, port 1004, or port 1005. Port 1000 and port 1001 may be associated with a first CDM group (e.g., CDM group #0). Port 1002 and port 1003 may be associated with a second CDM group (e.g., CDM group #1). Port 1004 and port 1005 may be associated with a third CDM group (e.g., CDM group #2).

As shown by reference number 504, a DMRS configuration may be for a PDSCH and may be associated with a configuration type-2. The DMRS configuration may be associated with two OFDM symbols. A starting position of a DMRS may be in OFDM symbol 2 or OFDM symbol 3. The DMRS configuration may be associated with DMRS patterns, which may be orthogonal in two-by-two (in frequency and time) RE sets. The DMRS may be associated with a port, such as port 1000, port 1001, port 1002, port 1003, port 1004, port 1005, port 1006, port 1007, port 1008, port 1009, port 1010, or port 1011. Port 1000, port 1001, port 1006, and port 1007 may be associated with a first CDM group (e.g., CDM group #0). Port 1002, port 1003, port 1008, and port 1009 may be associated with a second CDM group (e.g., CDM group #1). Port 1004, port 1005, port 1010, and port 1011 may be associated with a third CDM group (e.g., CDM group #2).

As indicated above. FIG. 5 is provided as an example. Other examples may differ from what is described with regard to FIG. 5.

Different quasi co-locations (QCLs) may be associated with different CDM groups. A UE may assume that PDSCH DMRSs within a same CDM group are quasi co-located with respect to a Doppler shift, a Doppler spread, an average delay, a delay spread, and/or a spatial Rx. When a UE is configured by a physical downlink control channel (PDCCH) configuration (PDCCH-Config) higher layer parameter that indicates two different values of a control resource set (CORESET) pool index (coresetPoolIndex), the UE may be scheduled with fully or partially overlapping PDSCHs in a time and frequency domain by multiple PDCCHs. The UE may not be expected to assume DMRS ports in a CDM group indicated by two transmission configuration indicator (TCI) states.

In an air-to-ground network, a relatively high cell-edge throughput via a multi-TRP configuration may be desired for aircraft. The air-to-ground network may be expected to support rank-2 transmissions without cross polarization or rank-4 transmissions with cross polarization, where a rank (e.g., rank-2 or rank-4) may be associated with a quantity of layers or data streams. However, to enable the relatively high cell-edge throughput, a relatively large cyclic prefix length may be needed for multiple paths (e.g., due to mountains or other obstacles) and different distances from multiple base stations. The multiple base stations may be associated with a multi-TRP configuration. A relatively small subcarrier spacing (e.g., 7.5 kHz or 15 kHz) may be preferred due to the relatively large cyclic prefix length. Opposite Doppler shifts associated with different TRPs may be a problem for channel estimation with a relatively small subcarrier spacing. For example, an f_{d,max}, which may represent a maximum Doppler frequency shift, may be about 5.33 kHz, which may be about 33% of a subcarrier spacing at 4.8 GHz with the subcarrier spacing being equal to 15 kHz. The f_{d,max} may be problematic for channel estimation as frequency division multiplexed DMRS ports may be interfering with other frequency division multiplexed DMRS ports. The opposite Doppler shifts may prevent a UE from accurately estimating a channel associated with different CDM groups.

In various aspects of techniques and apparatuses described herein, a UE may receive, from a base station, a configuration that defines a quantity of additional guard REs in a frequency domain between different frequency division multiplexed DMRS CDM groups. The additional guard REs in the frequency domain may not be associated with signal transmissions. The UE may perform a channel estimation based at least in part on the quantity of additional guard REs in the frequency domain between the different frequency division multiplexed DMRS CDM groups. The UE may perform the channel estimation based at least in part on DMRS REs associated with the different frequency division multiplexed DMRS CDM groups, where DMRS REs associated with a first frequency division multiplexed DMRS CDM group may be separated from DMRS REs associated with a second frequency division multiplexed DMRS CDM group by the quantity of additional guard REs in the frequency domain. The quantity of additional guard REs in the frequency domain may prevent interference between frequency division multiplexed DMRS ports, thereby improving the channel estimation.

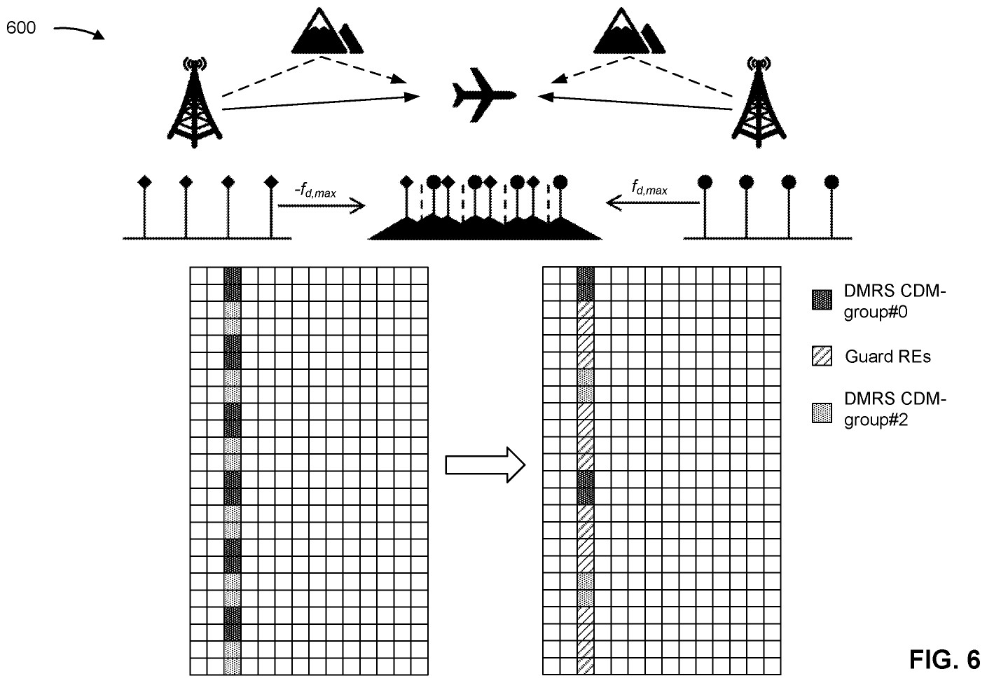

FIG. 6 is a diagram illustrating an example 600 associated with additional guard REs between frequency division multiplexed DMRS CDM groups, in accordance with the present disclosure.

As shown in FIG. 6, additional guard REs may be added between frequency division multiplexed DMRS CDM groups, which may be associated with different TRPs (or different base stations). The additional guard REs may prevent interference between frequency division multiplexed DMRS ports and improve channel estimation. No DMRSs may be transmitted in the additional guard REs. For example, instead of DMRSs in a frequency domain being associated with a first DMRS CDM group (e.g., DMRS CDM-group #0) or a second DMRS CDM group (e.g., DMRS CDM-group #1) without in-between REs, the additional guard REs may be added between the REs associated with the first DMRS CDM group and the second DMRS CDM group. The additional guard REs may prevent the interference between the frequency division multiplexed DMRS ports, while still maintaining a relatively low subcarrier spacing for a relatively large cyclic prefix length. The additional guard REs may increase an energy-per resource element (EPRE) associated with the DMRSs. As a result, a UE may more accurately perform channel estimation. Further, the UE may use Rx-combining and/or beam forming to carry out sequential MIMO demodulation.

As indicated above, FIG. 6 is provided as an example. Other examples may differ from what is described with regard to FIG. 6.

In some aspects, a UE (e.g., an aircraft UE) may be configured with additional guard REs in a frequency domain between different frequency division multiplexed PDSCH-DMRS CDM-groups. The UE may assume that no signals are transmitted on the guard REs. A quantity of additional guard REs may be based at least in part on a (pre)-configuration. Alternatively, the quantity of additional guard REs may be indicated via radio resource control (RRC) signaling or a medium access control control element (MAC-CE), which may involve signaling downlink control information (DCI) that indicates the quantity of additional guard REs.

In some aspects, the quantity of additional guard REs may be based at least in part on a DMRS configuration type-1 or a DMRS configuration type-2. In some aspects, the quantity of additional guard REs may be based at least in part on whether a DMRS is associated with one OFDM symbol or two OFDM symbols. In some aspects, the quantity of additional guard REs may be based at least in part on a quantity of CDM groups (e.g., two CDM groups or three CDM groups). For example, for three CDM groups, a quantity of additional guard REs between different adjacent CDM group pairs may be different, based at least in part on different maximum Doppler frequency shifts with certain geometries. In some aspects, the quantity of additional guard REs may be based at least in part on a subcarrier spacing of a PDSCH. For example, fewer additional guard REs may be employed for a subcarrier spacing of 30 kHz as compared to other subcarrier spacings, while greater additional guard REs may be employed for a subcarrier spacing of 15 kHz as compared to other subcarrier spacings.

In some aspects, additional guard REs may be semi-statically configured, or an indication of the additional guard REs may be indicated in a DCI scheduling the PDSCH. A configuration of the additional guard REs, which may be semi-statically configured or indicated via the DCI scheduling the PDSCH, may be selected from a plurality of possible configurations. The configuration of the additional guard REs may be associated with a DMRS pattern with additional guard REs that expand more than one physical resource block (PRB).

In some aspects, a UE may transmit, to a base station, an indication of a preferred quantity of additional guard REs. The base station may transmit, to the UE, a configuration for the additional guard REs. The configuration for the additional guard REs may be based at least in part on the indication of the preferred quantity of additional guard REs.

FIG. 7 is a diagram illustrating an example associated with additional guard REs in a frequency domain, in accordance with the present disclosure. As shown in FIG. 7, example 700 includes communication between a UE (e.g., UE 120) and a base station (e.g., base station 110). In some aspects, the UE and the base station may be included in a wireless network, such as wireless network 100.

As shown by reference number 702, the UE may receive, from the base station, a configuration that defines a quantity of additional guard REs in a frequency domain between different frequency division multiplexed DMRS CDM groups. The additional guard REs in the frequency domain may not be associated with signal transmissions. In some aspects, the quantity of additional guard REs may be associated with a DMRS pattern. The DMRS pattern may be associated with one or more PRBs. In some aspects, the different frequency division multiplexed DMRS CDM groups may be associated with a PDSCH, a physical uplink shared channel (PUSCH), or a physical sidelink shared channel (PSSCH).

In some aspects, the UE may receive the configuration via RRC signaling, a MAC-CE, or DCI. In some aspects, the configuration may be a semi-static configuration. In some aspects, the UE may receive the configuration in a scheduling DCI associated with a downlink channel or an uplink channel. In some aspects, the UE may receive RRC signaling that indicates multiple possible configurations for quantities of additional guard REs in the frequency domain, and the UE may subsequently receive DCI that indicates a selection of one of the multiple possible configurations.

In some aspects, the different frequency division multiplexed DMRS CDM groups may include a first DMRS CDM group and a second DMRS CDM group. The first DMRS CDM group may be associated with a first quasi co-location and/or a first TRP. The second DMRS CDM group may be associated with a second quasi co-location and/or a second TRP.

In some aspects, the UE and the base station may be associated with an air-to-ground network. In some aspects, the UE and the base station may be associated with a terrestrial network that supports a relatively high-speed highway.

In some aspects, the quantity of additional guard REs in the frequency domain may be based at least in part on a DMRS configuration type-1 or a DMRS configuration type-2. In some aspects, the quantity of additional guard REs in the frequency domain may be based at least in part on a quantity of symbols associated with a DMRS pattern. In some aspects, the quantity of additional guard REs in the frequency domain may be based at least in part on a quantity associated with the different frequency division multiplexed DMRS CDM groups. In some aspects, the quantity of additional guard REs in the frequency domain is based at least in part on a subcarrier spacing associated with the downlink channel or the uplink channel. In some aspects, the quantity of additional guard REs may be associated with different quantities of additional guard REs between different pairs of frequency division multiplexed DMRS CDM groups.

In some aspects, the UE may transmit, to the base station, an indication that indicates a preferred quantity of additional guard REs in the frequency domain. The configuration that defines the quantity of additional guard REs in the frequency domain may be based at least in part on the indication.

In some aspects. DMRS REs associated with the different frequency division multiplexed DMRS CDM groups may be associated with an EPRE boosting. The EPRE boosting of the DMRS REs may be based at least in part on a presence of the additional guard REs in the frequency domain. In some aspects, the EPRE boosting may be based at least in part on the quantity of additional guard REs per PRB and per symbol used between the different frequency division multiplexed DMRS CDM groups, where the quantity of additional guard REs may be averaged over multiple PRBs spanning a DMRS pattern. In some aspects, the UE may determine an offset on a ratio between a downlink channel EPRE and a DMRS EPRE on DMRS REs based at least in part on a presence of the additional guard REs in the frequency domain.

In some aspects, the UE may determine, based at least in part on the configuration, an identical pattern of additional guard REs in multiple time division multiplexed DMRS symbols. In some aspects, the UE may determine, based at least in part on the configuration, a staggered pattern of additional guard REs in multiple time division multiplexed DMRS symbols. The staggered pattern may be based at least in part on a cyclic shifting of the different frequency division multiplexed DMRS CDM groups in the frequency domain. The cyclic shifting may be based at least in part on a quantity of DMRS symbols time division multiplexed within a single slot.

In some aspects, the UE may determine, based at least in part on the configuration, the quantity of additional guard REs on different time division multiplexed DMRS symbols within a single slot. The quantity of additional guard REs may be associated with a same quantity or different quantities on the different time division multiplexed DMRS symbols within the single slot. The quantity of additional guard REs may be associated with the same quantity or the different quantities based at least in part on a DMRS configuration type-1 or a DMRS configuration type-2, a quantity of symbols associated with a DMRS pattern, a quantity associated with the different frequency division multiplexed DMRS CDM groups, a subcarrier spacing associated with the downlink channel or the uplink channel, and/or a quantity of time division multiplexed DMRS symbols within the single slot.

In some aspects, the UE may determine, based at least in part on the configuration, whether to map DMRS REs associated with a DMRS symbol onto a quantity of available REs. The quantity of additional guard REs may cause the quantity of available REs to not satisfy a threshold. In some aspects, the UE may map the DMRS REs onto the quantity of available REs with corresponding orthogonal cover codes (OCCs). Alternatively, the UE may refrain from mapping the DMRS REs onto the quantity of available REs.

As shown by reference number 704, the UE may perform a channel estimation based at least in part on the quantity of additional guard REs in the frequency domain between the different frequency division multiplexed DMRS CDM groups. For example, the UE may perform the channel estimation based at least in part on DMRS REs associated with the different frequency division multiplexed DMRS CDM groups.

As indicated above, FIG. 7 is provided as an example. Other examples may differ from what is described with regard to FIG. 7.

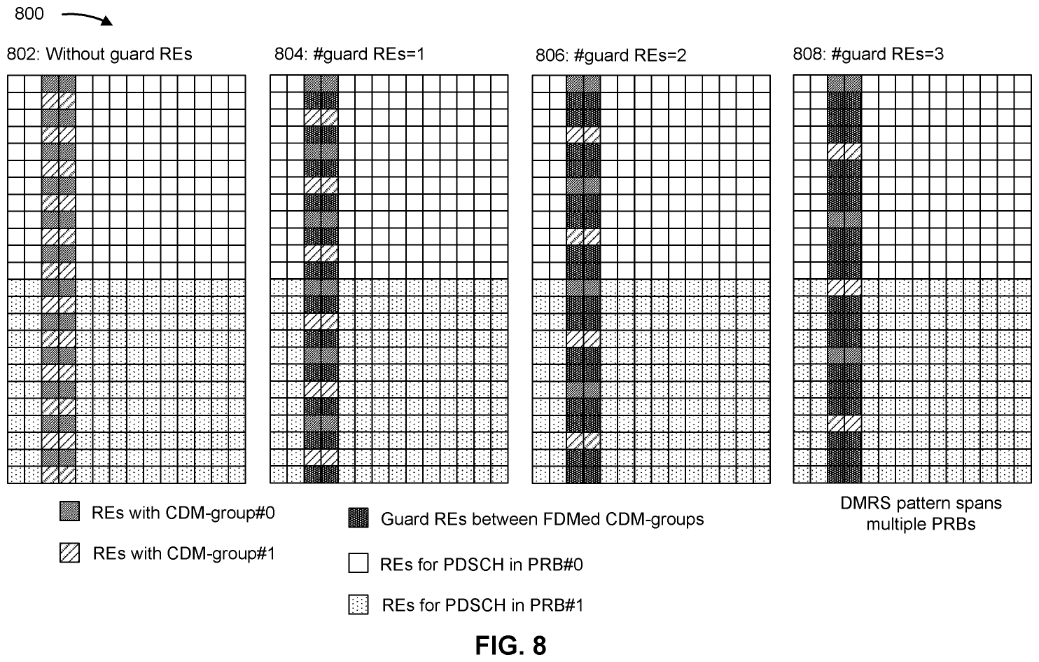

FIG. 8 is a diagram illustrating an example 800 associated with additional guard REs between frequency division multiplexed DMRS CDM groups, in accordance with the present disclosure.

Additional guard REs may be employed in a frequency domain between frequency division multiplexed CDM groups for a DMRS configuration type-1. A first set of REs may be associated with a first CDM group (e.g., CDM-group #0) and a second set of REs may be associated with a second CDM group (e.g., CDM-group #1). The first CDM group may be associated with a first TRP (e.g., TRP #0), and the second CDM group may be associated with a second TRP (e.g., TRP #1). REs associated with the first CDM group and the second CDM group, respectively, may be associated with either a first group of REs for a PDSCH in a first PRB (PRB #0) or a second group of REs for a PDSCH in a second PRB (PRB #1). In some aspects, multiple CDM groups may be supported for two-symbol DMRS patterns in the DMRS configuration type-1.

As shown by reference number 802, no additional guard REs may be employed between frequency division multiplexed CDM groups. In other words, REs associated with the first CDM group and REs associated with the second CDM group may not be separated by additional guard REs.

As shown by reference number 804, a quantity of additional guard REs that are employed between frequency division multiplexed CDM groups may be equal to one. In other words, REs associated with the first CDM group and REs associated with the second CDM group may be separated by one additional guard RE in the frequency domain.

As shown by reference number 806, a quantity of additional guard REs that are employed between frequency division multiplexed CDM groups may be equal to two. In other words, REs associated with the first CDM group and REs associated with the second CDM group may be separated by two additional guard REs in the frequency domain.

As shown by reference number 808, a quantity of additional guard REs that are employed between frequency division multiplexed CDM groups may be equal to three. In other words. REs associated with the first CDM group and REs associated with the second CDM group may be separated by three additional guard REs in the frequency domain. In some aspects, a DMRS pattern associated with the quantity of additional guard REs may span multiple PRBs.

As indicated above, FIG. 8 is provided as an example. Other examples may differ from what is described with regard to FIG. 8.

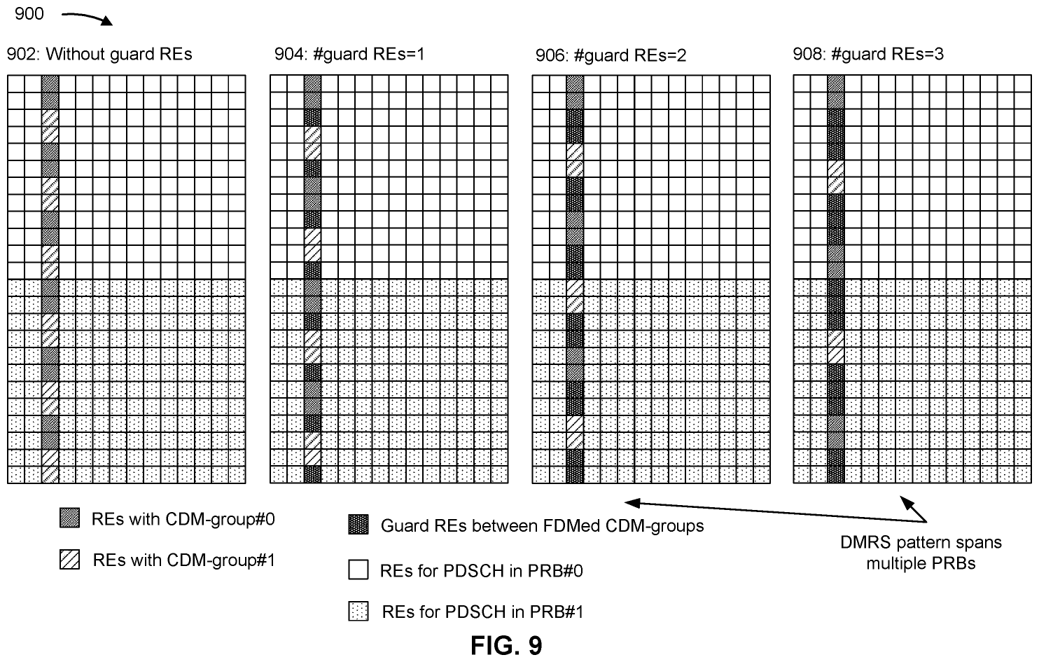

FIG. 9 is a diagram illustrating an example 900 associated with additional guard REs between frequency division multiplexed DMRS CDM groups, in accordance with the present disclosure.

Additional guard REs may be employed in a frequency domain between frequency division multiplexed CDM groups for a DMRS configuration type-2, which may be associated with a one-symbol DMRS pattern. A first set of REs may be associated with a first CDM group (e.g., CDM-group #0) and a second set of REs may be associated with a second CDM group (e.g., CDM-group #1). The first CDM group may be associated with a first TRP (e.g., TRP #0), and the second CDM group may be associated with a second TRP (e.g., TRP #1). REs associated with the first CDM group and the second CDM group, respectively, may be associated with either a first group of REs for a PDSCH in a first PRB (PRB #0) or a second group of REs for a PDSCH in a second PRB (PRB #1).

As shown by reference number 902, no additional guard REs may be employed between frequency division multiplexed CDM groups. In other words, REs associated with the first CDM group and REs associated with the second CDM group may not be separated by additional guard REs.

As shown by reference number 904, a quantity of additional guard REs that are employed between frequency division multiplexed CDM groups may be equal to one. In other words, REs associated with the first CDM group and REs associated with the second CDM group may be separated by one additional guard RE in the frequency domain.

As shown by reference number 906, a quantity of additional guard REs that are employed between frequency division multiplexed CDM groups may be equal to two. In other words, REs associated with the first CDM group and REs associated with the second CDM group may be separated by two additional guard REs in the frequency domain. In some aspects, a DMRS pattern associated with the quantity of additional guard REs may span multiple PRBs.

As shown by reference number 908, a quantity of additional guard REs that are employed between frequency division multiplexed CDM groups may be equal to three. In other words, REs associated with the first CDM group and REs associated with the second CDM group may be separated by three additional guard REs in the frequency domain. In some aspects, a DMRS pattern associated with the quantity of additional guard REs may span multiple PRBs.

As indicated above. FIG. 9 is provided as an example. Other examples may differ from what is described with regard to FIG. 9.

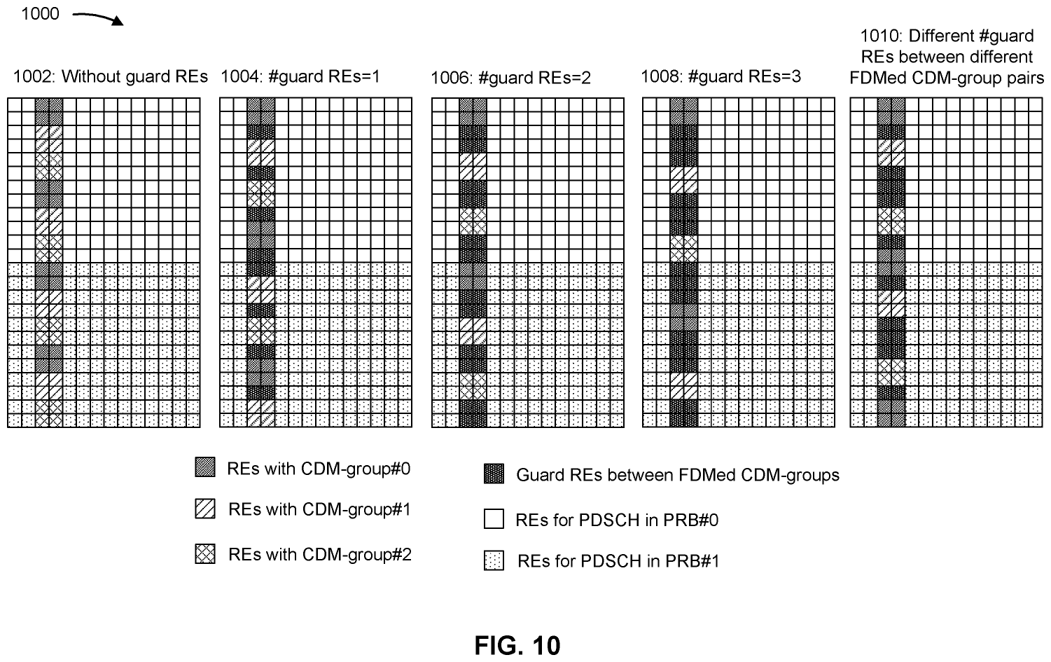

FIG. 10 is a diagram illustrating an example 1000 associated with additional guard REs between frequency division multiplexed DMRS CDM groups, in accordance with the present disclosure.

Additional guard REs may be employed in a frequency domain between frequency division multiplexed CDM groups for a DMRS configuration type-2, which may be associated with a two-symbol DMRS pattern. A first set of REs may be associated with a first CDM group (e.g., CDM-group #0), a second set of REs may be associated with a second CDM group (e.g., CDM-group #1), and a third set of REs may be associated with a third CDM group (e.g., CDM-group #2). The first CDM group may be associated with a first TRP (e.g., TRP #0), the second CDM group may be associated with a second TRP (e.g., TRP #1), and the third CDM group may be associated with a third TRP (e.g., TRP #2). REs associated with the first CDM group, the second CDM group, and the third CDM group, respectively, may be associated with either a first group of REs for a PDSCH in a first PRB (PRB #0) or a second group of REs for a PDSCH in a second PRB (PRB #1).

As shown by reference number 1002, no additional guard REs may be employed between frequency division multiplexed CDM groups. In other words. REs associated with the first CDM group, REs associated with the second CDM group, and/or REs associated with the third CDM group may not be separated by additional guard REs.

As shown by reference number 1004, a quantity of additional guard REs that are employed between frequency division multiplexed CDM groups may be equal to one. In other words, REs associated with the first CDM group. REs associated with the second CDM group, and/or REs associated with the third CDM group may be separated by one additional guard RE in the frequency domain.

As shown by reference number 1006, a quantity of additional guard REs that are employed between frequency division multiplexed CDM groups may be equal to two. In other words, REs associated with the first CDM group, REs associated with the second CDM group, and/or REs associated with the third CDM group may be separated by two additional guard REs in the frequency domain.

As shown by reference number 1008, a quantity of additional guard REs that are employed between frequency division multiplexed CDM groups may be equal to three. In other words, REs associated with the first CDM group, REs associated with the second CDM group, and/or REs associated with the third CDM group may be separated by three additional guard REs in the frequency domain. In some aspects, a DMRS pattern associated with the quantity of additional guard REs may span multiple PRBs.

As shown by reference number 1010, a quantity of additional guard REs that are employed between frequency division multiplexed CDM groups may be an adjustable quantity. In other words. REs associated with the first CDM group. REs associated with the second CDM group, and/or REs associated with the third CDM group may be separated by different quantities (e.g., one, two, or three) of additional guard REs in the frequency domain. The different quantities of additional guard REs may be employed between different pairs of frequency division multiplexed CDM groups. In some aspects, a DMRS pattern associated with the quantity of additional guard REs may span multiple PRBs. In some aspects, a relatively medium Doppler shift may be associated with the first CDM group and the second CDM group, and a relatively large Doppler shift may be associated with the third CDM group, so different quantities of additional guard REs may be employed between the first CDM group, the second CDM group, and/or the third CDM group.

As indicated above, FIG. 10 is provided as an example. Other examples may differ from what is described with regard to FIG. 10.

In some aspects, an EPRE boosting may be employed when additional guard REs are employed between frequency division multiplexed DMRS CDM groups. The EPRE boosting may be based at least in part on a quantity of additional guard REs per PRB per symbol employed between the frequency division multiplexed DMRS CDM groups. The quantity of additional guard REs may be averaged over multiple PRBs spanning a DMRS pattern.

In some aspects, the EPRE boosting may involve boosting a transmission power associated with DMRS REs. When the additional guard REs are employed, fewer DMRSs may be received at a UE, so the EPRE boosting may improve a received power associated with the DMRSs at the UE. The EPRE boosting may improve a channel estimation at the UE based at least in part on a higher transmission power associated with the DMRS REs that are used for the channel estimation.

In some aspects, the UE may identify an offset on a ratio between a PDSCH EPRE and a DMRS EPRE on DMRS REs, when the additional guard REs are employed between the frequency division multiplexed DMRS CDM groups. The offset on the ratio may be in relation to no additional guard REs being employed.

As an example, four REs may be used as additional guard REs per PRB per symbol (e.g., ⅓ DMRS power loss). An offset on a ratio between a PDSCH EPRE and a DMRS EPRE may be 10*log 10(⅔), or −1.76 dB. As another example, six REs may be used as additional guard REs per PRB per symbol (e.g., 50% DMRS power loss). An offset on a ratio between a PDSCH EPRE and a DMRS EPRE may be 10*log 10(½), or −3 dB.

In some aspects, additional guard REs may degrade a channel estimation performance in a frequency domain. A staggered pattern of additional guard REs between frequency division multiplexed DMRS CDM groups may compensate for channel estimation degradation. In some aspects, the UE may identify identical patterns of additional guard REs in multiple time division multiplexed DMRS symbols. In some aspects, the UE may also identify a staggered pattern of additional guard REs in multiple time division multiplexed DMRS symbols. The staggered pattern of additional guard REs may be based at least in part on a cyclic shifting of different CDM groups in the frequency domain. In some aspects, cyclic shift values may be indicated via RRC signaling, a MAC-CE, or DCI. In some aspects, the cyclic shift values may be based at least in part on a quantity of DMRS symbols time division multiplexed within one slot. In some aspects, the UE may identify a staggered pattern associated with additional DMRS symbols when the UE successfully identifies additional guard REs for previous DMRS symbols.

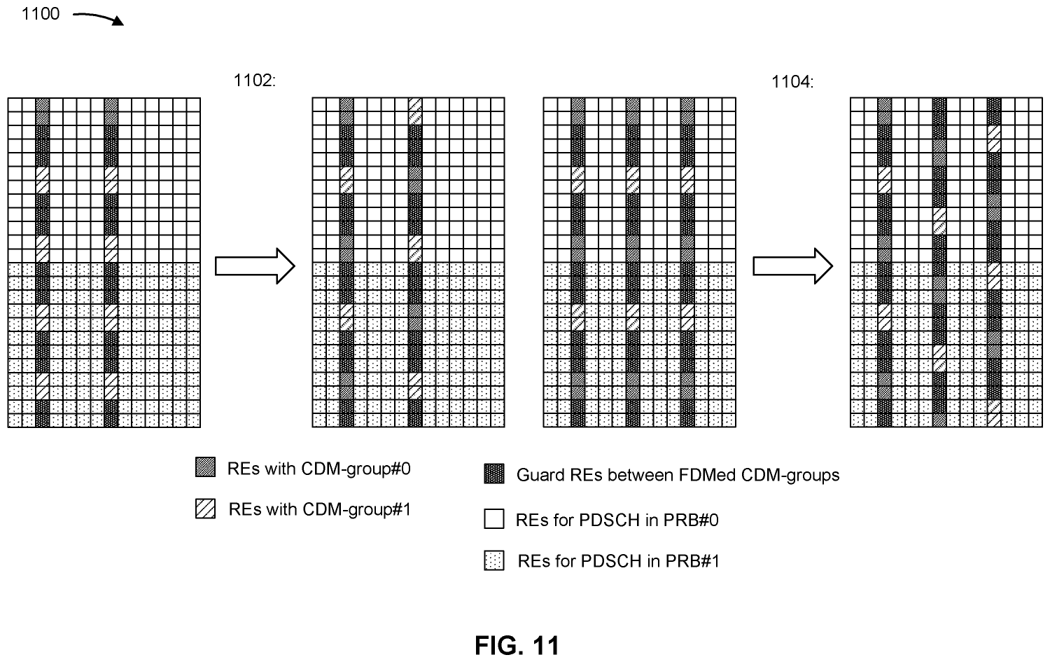

FIG. 11 is a diagram illustrating an example 1100 associated with a staggered pattern of additional guard REs between frequency division multiplexed DMRS CDM groups, in accordance with the present disclosure.

As shown by reference number 1102, an identical pattern of additional guard REs may be associated with multiple time division multiplexed DMRS symbols. For example, an identical pattern of additional guard REs may be associated with both OFDM symbol 2 and OFDM symbol 7. Further, the staggered pattern of additional guard REs may be associated with multiple time division multiplexed DMRS symbols. The staggered pattern of additional guard REs may be based at least in part on a cyclic shift of different CDM groups in a frequency domain. For example, the staggered pattern of additional guard REs may be based at least in part on a cyclic shift of a first CDM group and/or a second CDM group with respect to OFDM symbol 2 and OFDM symbol 7 in the frequency domain.

As shown by reference number 1104, an identical pattern of additional guard REs may be associated with multiple time division multiplexed DMRS symbols. For example, an identical pattern of additional guard REs may be associated with OFDM symbol 2, OFDM symbol 6, and OFDM symbol 10. Further, the staggered pattern of additional guard REs may be associated with multiple time division multiplexed DMRS symbols. The staggered pattern of additional guard REs may be based at least in part on a cyclic shift of different CDM groups in a frequency domain. For example, the staggered pattern of additional guard REs may be based at least in part on a cyclic shift of a first CDM group, a second CDM group, and/or a third CDM group with respect to OFDM symbol 2. OFDM symbol 6, and OFDM symbol 10 in the frequency domain.

As indicated above, FIG. 11 is provided as an example. Other examples may differ from what is described with regard to FIG. 11.

In some aspects, additional guard REs may be configured in a frequency domain between different frequency division multiplexed PDSCH DMRS CDM groups. Alternatively, additional guard REs may be configured in a frequency domain between different frequency division multiplexed PUSCH DMRS CDM groups or between different frequency division multiplexed PSSCH DMRS CDM groups.

In some aspects, a different quantity of additional guard REs may be associated with different DMRS symbols. A UE may identify a same quantity of additional guard REs or different quantities of additional guard REs on different time division multiplexed DMRS symbols within one slot. The same or different quantities of additional guard REs in the different DMRS symbols may be based at least in part on RRC signaling, a MAC-CE, or DCI. In some aspects, the same or different quantities of additional guard REs in the different DMRS symbols may be based at least in part on a DMRS configuration type-1 or a DMRS configuration type-2. In some aspects, the same or different quantities of additional guard REs in the different DMRS symbols may be based at least in part on a quantity of OFDM symbols (e.g., one OFDM symbol or two OFDM symbols). In some aspects, the same or different quantities of additional guard REs in the different DMRS symbols may be based at least in part on a quantity of CDM groups (e.g., two CDM groups or three CDM groups). In some aspects, the same or different quantities of additional guard REs in the different DMRS symbols may be based at least in part on a subcarrier spacing of a PDSCH. For example, fewer additional guard REs may be employed for a subcarrier spacing of 30 kHz as compared to other subcarrier spacings, while greater additional guard REs may be employed for a subcarrier spacing of 15 kHz as compared to other subcarrier spacings. In some aspects, the same or different quantities of additional guard REs in the different DMRS symbols may be based at least in part on a quantity of time division multiplexed DMRS symbols within one slot.

In some aspects, insufficient REs may be available at an end of a DMRS symbol to map DMRS REs for a certain CDM group. Insufficient REs may be unavailable based at least in part on additional guard REs that are employed between frequency division multiplexed CDM groups. In this case, a part of a corresponding DMRS RE may be mapped onto available RE(s), and with corresponding OCCs for the available RE(s). The part of the corresponding DMRS RE may be mapped onto the available RE(s) when no other UEs are multiplexed within a same CDM group. Alternatively, the available RE(s) may be used as additional guard REs. In other words, a part of a corresponding DMRS RS may not be mapped onto the available RE(s).

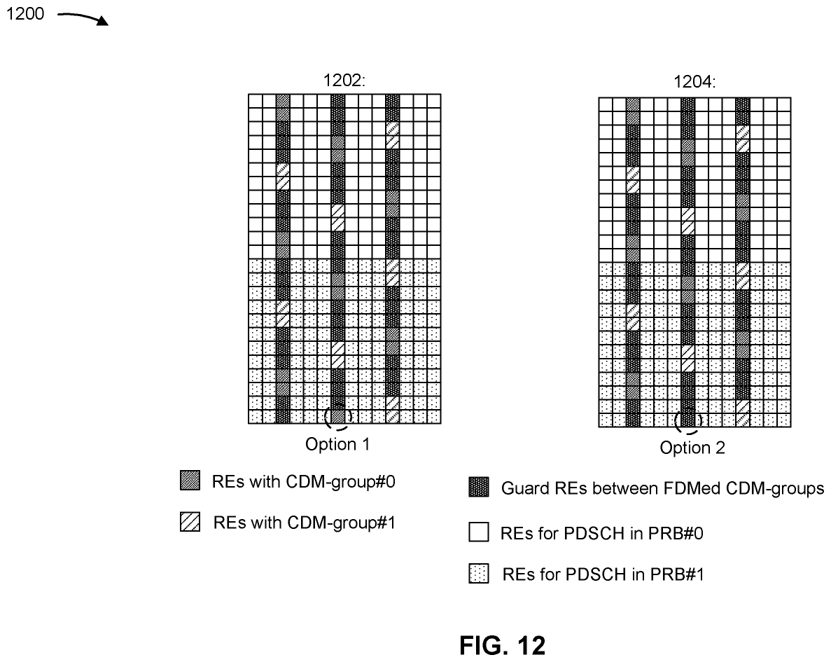

FIG. 12 is a diagram illustrating an example 1200 associated with mapping available RE(s), in accordance with the present disclosure.

As shown by reference number 1202, available RE(s) may occur at an end of a DMRS symbol to map DMRS REs for a certain CDM group. However, a quantity associated with the available RE(s) may be insufficient to map the DMRS REs for the certain CDM group. In some aspects, a part of a corresponding DMRS RE may be mapped onto the available RE(s), and with corresponding OCCs for the available RE(s). The part of the corresponding DMRS RE may be mapped onto the available RE(s) when no other UEs are multiplexed within a same CDM group.

As shown by reference number 1204, available RE(s) may occur at an end of a DMRS symbol to map DMRS REs for a certain CDM group. However, a quantity associated with the available RE(s) may be insufficient to map the DMRS REs for the certain CDM group. In some aspects, the available RE(s) may be used as additional guard REs. In other words, a part of a corresponding DMRS RS may not be mapped onto the available RE(s).

As indicated above. FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120) performs operations associated with additional guard REs in a frequency domain.

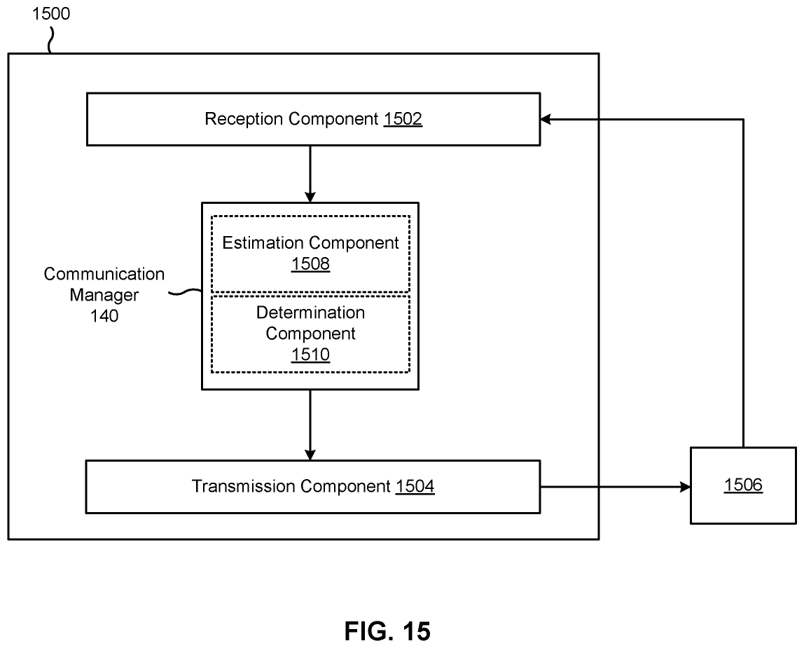

As shown in FIG. 13, in some aspects, process 1300 may include receiving, from a base station, a configuration that defines a quantity of additional guard REs in a frequency domain between different frequency division multiplexed DMRS CDM groups, wherein the additional guard REs in the frequency domain are not associated with signal transmissions (block 1310). For example, the UE (e.g., using communication manager 140 and/or reception component 1502, depicted in FIG. 15) may receive, from a base station, a configuration that defines a quantity of additional guard REs in a frequency domain between different frequency division multiplexed DMRS CDM groups, wherein the additional guard REs in the frequency domain are not associated with signal transmissions, as described above in connection with FIGS. 7-12.

Process 1300 may include additional aspects, such as any single aspect or any combination of aspects described below and/or in connection with one or more other processes described elsewhere herein.

In a first aspect, process 1300 includes receiving the configuration via one of RRC signaling, a MAC-CE, or DCI.

In a second aspect, alone or in combination with the first aspect, the quantity of additional guard REs in the frequency domain is based at least in part on a DMRS configuration type-1 or a DMRS configuration type-2.

Ina third aspect, alone or in combination with one or more of the first and second aspects, the quantity of additional guard REs in the frequency domain is based at least in part on a quantity of symbols associated with a DMRS pattern.

In a fourth aspect, alone or in combination with one or more of the first through third aspects, the quantity of additional guard REs in the frequency domain is based at least in part on a quantity associated with the different frequency division multiplexed DMRS CDM groups.

In a fifth aspect, alone or in combination with one or more of the first through fourth aspects, the quantity of additional guard REs in the frequency domain is based at least in part on a subcarrier spacing associated with a downlink channel or an uplink channel.

In a sixth aspect, alone or in combination with one or more of the first through fifth aspects, process 1300 includes receiving a semi-static configuration that defines the quantity of additional guard REs in the frequency domain; receiving the configuration in a scheduling DCI associated with a downlink channel or an uplink channel; or receiving RRC signaling that indicates multiple possible configurations for quantities of additional guard REs in the frequency domain, and receiving DCI that indicates a selection of one of the multiple possible configurations.

In a seventh aspect, alone or in combination with one or more of the first through sixth aspects, process 1300 includes transmitting, to the base station, an indication that indicates a preferred quantity of additional guard REs in the frequency domain, wherein the configuration that defines the quantity of additional guard REs in the frequency domain is based at least in part on the indication.

In an eighth aspect, alone or in combination with one or more of the first through seventh aspects, the quantity of additional guard REs are associated with a DMRS pattern, and the DMRS pattern is associated with more than one PRB.

In a ninth aspect, alone or in combination with one or more of the first through eighth aspects, the quantity of additional guard REs are associated with different quantities of additional guard REs between different pairs of frequency division multiplexed DMRS CDM groups.

Ina tenth aspect, alone or in combination with one or more of the first through ninth aspects. DMRS REs associated with the different frequency division multiplexed DMRS CDM groups are associated with an EPRE boosting, wherein the EPRE boosting of the DMRS REs is based at least in part on a presence of the additional guard REs in the frequency domain, wherein the EPRE boosting is based at least in part on the quantity of additional guard REs per physical resource block (PRB) and per symbol used between the different frequency division multiplexed DMRS CDM groups, and wherein the quantity of additional guard REs is averaged over multiple PRBs spanning a DMRS pattern.

In an eleventh aspect, alone or in combination with one or more of the first through tenth aspects, process 1300 includes determining an offset on a ratio between a downlink channel EPRE and a DMRS EPRE on DMRS REs based at least in part on a presence of the additional guard REs in the frequency domain.

In a twelfth aspect, alone or in combination with one or more of the first through eleventh aspects, process 1300 includes determining, based at least in part on the configuration, a pattern of additional guard REs in multiple time division multiplexed DMRS symbols.

In a thirteenth aspect, alone or in combination with one or more of the first through twelfth aspects, process 1300 includes determining, based at least in part on the configuration, a staggered pattern of additional guard REs in multiple time division multiplexed DMRS symbols.

In a fourteenth aspect, alone or in combination with one or more of the first through thirteenth aspects, the staggered pattern is based at least in part on a cyclic shifting of the different frequency division multiplexed DMRS CDM groups in the frequency domain, and the cyclic shifting is based at least in part on a quantity of DMRS symbols time division multiplexed within a single slot.

In a fifteenth aspect, alone or in combination with one or more of the first through fourteenth aspects, the different frequency division multiplexed DMRS CDM groups are associated with one of a PDSCH, a PUSCH, or a PSSCH.

In a sixteenth aspect, alone or in combination with one or more of the first through fifteenth aspects, process 1300 includes determining, based at least in part on the configuration, the quantity of additional guard REs on different time division multiplexed DMRS symbols within a single slot, wherein the quantity of additional guard REs are associated with a same quantity or different quantities on the different time division multiplexed DMRS symbols within the single slot based at least in part on one or more of: a DMRS configuration type-1 or a DMRS configuration type-2, a quantity of symbols associated with a DMRS pattern, a quantity associated with the different frequency division multiplexed DMRS CDM groups, a subcarrier spacing associated with a downlink channel or an uplink channel, or a quantity of time division multiplexed DMRS symbols within the single slot.

In a seventeenth aspect, alone or in combination with one or more of the first through sixteenth aspects, process 1300 includes determining, based at least in part on the configuration, whether to map DMRS REs associated with a DMRS symbol onto a quantity of available REs, wherein the quantity of additional guard REs causes the quantity of available REs to not satisfy a threshold, wherein the DMRS REs are mapped onto the quantity of available REs with corresponding orthogonal cover codes, or wherein the DMRS REs are refrained from being mapped onto the quantity of available REs.

In an eighteenth aspect, alone or in combination with one or more of the first through seventeenth aspects, the UE and the base station are associated with an air-to-ground network.

As further shown in FIG. 13, in some aspects, process 1300 may include performing a channel estimation based at least in part on the quantity of additional guard REs in the frequency domain between the different frequency division multiplexed DMRS CDM groups (block 1320). For example, the UE (e.g., using communication manager 140 and/or estimation component 1508, depicted in FIG. 15) may perform a channel estimation based at least in part on the quantity of additional guard REs in the frequency domain between the different frequency division multiplexed DMRS CDM groups, as described above in connection with FIGS. 7-12.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a base station, in accordance with the present disclosure. Example process 1400 is an example where the base station (e.g., base station 110) performs operations associated with additional guard REs in a frequency domain.

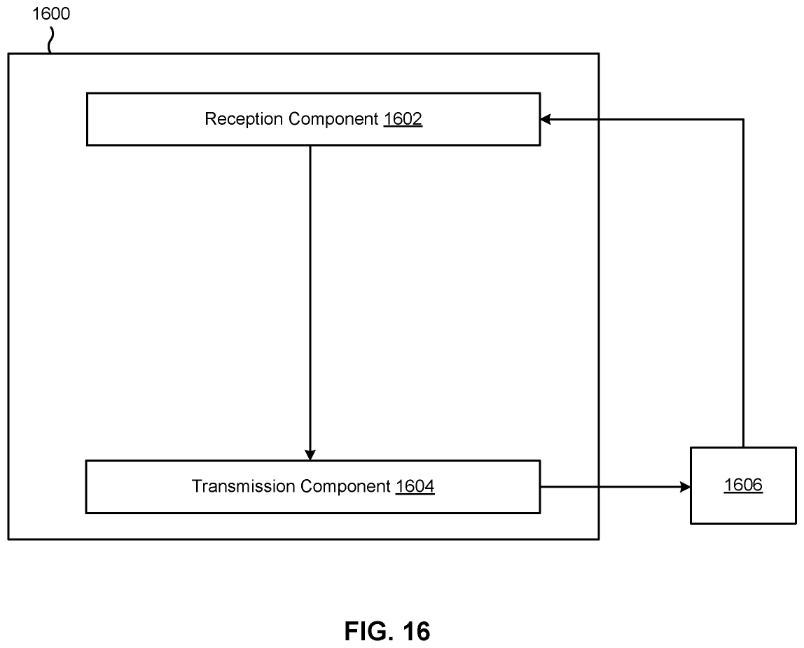

As shown in FIG. 14, in some aspects, process 1400 may include transmitting, to a UE, a configuration that defines a quantity of additional guard REs in a frequency domain between different frequency division multiplexed DMRS CDM groups, wherein the additional guard REs in the frequency domain are not associated with signal transmissions (block 1410). For example, the base station (e.g., using communication manager 150 and/or transmission component 1604, depicted in FIG. 16) may transmit, to a UE, a configuration that defines a quantity of additional guard REs in a frequency domain between different frequency division multiplexed DMRS CDM groups, wherein the additional guard REs in the frequency domain are not associated with signal transmissions, as described above in connection with FIGS. 7-12.

As further shown in FIG. 14, in some aspects, process 1400 may include transmitting, to the UE, one or more DMRS symbols, wherein the one or more DMRS symbols are associated with one of the different frequency division multiplexed DMRS CDM groups, and a channel estimation is based at least in part on the one or more DMRS symbols and the quantity of additional guard REs in the frequency domain between the different frequency division multiplexed DMRS CDM groups (block 1420). For example, the base station (e.g., using communication manager 150 and/or transmission component 1604, depicted in FIG. 16) may transmit, to the UE, one or more DMRS symbols, wherein the one or more MRS symbols are associated with one of the different frequency division multiplexed DMRS CDM groups, and a channel estimation is based at least in part on the one or more DMRS symbols and the quantity of additional guard REs in the frequency domain between the different frequency division multiplexed DMRS CDM groups, as described above in connection with FIGS. 7-12.

Process 1400 may include additional aspects, such as any single aspect or any combination of aspects described below and/or in connection with one or more other processes described elsewhere herein.

In a first aspect, the quantity of additional guard REs in the frequency domain is based at least in part on a quantity of symbols associated with a DMRS pattern; the quantity of additional guard REs in the frequency domain is based at least in part on a quantity associated with the different frequency division multiplexed DMRS CDM groups; or the quantity of additional guard REs in the frequency domain is based at least in part on a subcarrier spacing associated with a downlink channel or an uplink channel.

In a second aspect, alone or in combination with the first aspect, process 1400 includes receiving, from the UE, an indication that indicates a preferred quantity of additional guard REs in the frequency domain, wherein the configuration that defines the quantity of additional guard REs in the frequency domain is based at least in part on the indication.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a block diagram of an example apparatus 1500 for wireless communication. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include one or more of an estimation component 1508, or a determination component 1510, among other examples.

In some aspects, the apparatus 1500 may be configured to perform one or more operations described herein in connection with FIGS. 7-12. Additionally. or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1506. In some aspects, the reception component 1502 may include one or more antennas, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1506 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 may receive, from abase station, a configuration that defines a quantity of additional guard REs in a frequency domain between different frequency division multiplexed DMRS CDM groups, wherein the additional guard REs in the frequency domain are not associated with signal transmissions. The estimation component 1508 may perform a channel estimation based at least in part on the quantity of additional guard REs in the frequency domain between the different frequency division multiplexed DMRS CDM groups.

The transmission component 1504 may transmit, to the base station, an indication that indicates a preferred quantity of additional guard REs in the frequency domain, wherein the configuration that defines the quantity of additional guard REs in the frequency domain is based at least in part on the indication.

The determination component 1510 may determine an offset on a ratio between a downlink channel EPRE and a DMRS EPRE on DMRS REs based at least in part on a presence of the additional guard REs in the frequency domain. The determination component 1510 may determine, based at least in part on the configuration, a pattern of additional guard REs in multiple time division multiplexed DMRS symbols. The determination component 1510 may determine, based at least in part on the configuration, a staggered pattern of additional guard REs in multiple time division multiplexed DMRS symbols. The determination component 1510 may determine, based at least in part on the configuration, the quantity of additional guard REs on different time division multiplexed DMRS symbols within a single slot. The determination component 1510 may determine, based at least in part on the configuration, whether to map DMRS REs associated with a DMRS symbol onto a quantity of available REs.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally. or alternatively, a set of (one or more) components shown in FIG. 15 may perform one or more functions described as being performed by another set of components shown in FIG. 15.

FIG. 16 is a block diagram of an example apparatus 1600 for wireless communication. The apparatus 1600 may be a base station, or a base station may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604.

In some aspects, the apparatus 1600 may be configured to perform one or more operations described herein in connection with FIGS. 7-12. Additionally, or alternatively, the apparatus 1600 may be configured to perform one or more processes described herein, such as process 1400 of FIG. 14, or a combination thereof. In some aspects, the apparatus 1600 and/or one or more components shown in FIG. 16 may include one or more components of the base station described in connection with FIG. 2. Additionally, or alternatively, one or more components shown in FIG. 16 may be implemented within one or more components described in connection with FIG. 2. Additionally. or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1606. In some aspects, the reception component 1602 may include one or more antennas, a demodulator, a MIMO detector, a receive processor, a controller/processor, a memory, or a combination thereof, of the base station described in connection with FIG. 2.

The transmission component 1604 may transmit communications, such as reference signals, control information, data communications, or a combination thereof, to the apparatus 1606. In some aspects, one or more other components of the apparatus 1606 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modulator, a transmit MIMO processor, a transmit processor, a controller/processor, a memory, or a combination thereof, of the base station described in connection with FIG. 2. In some aspects, the transmission component 1604 may be co-located with the reception component 1602 in a transceiver.

The transmission component 1604 may transmit, to a UE, a configuration that defines a quantity of additional guard REs in a frequency domain between different frequency division multiplexed DMRS CDM groups. The transmission component 1604 may transmit, to the UE, one or more DMRS symbols, wherein the one or more DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups. The reception component 1602 may receive, from the UE, an indication that indicates a preferred quantity of additional guard REs in the frequency domain, wherein the configuration that defines the quantity of additional guard REs in the frequency domain is based at least in part on the indication.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by a user equipment (UE), comprising: receiving, from a base station, a configuration that defines a quantity of additional guard resource elements (REs) in a frequency domain between different frequency division multiplexed demodulation reference signal (DMRS) code division multiplexing (CDM) groups, wherein the additional guard REs in the frequency domain are not associated with signal transmissions; and performing a channel estimation based at least in part on the quantity of additional guard REs in the frequency domain between the different frequency division multiplexed DMRS CDM groups.
Aspect 2: The method of Aspect 1, wherein receiving the configuration that defines the quantity of additional guard REs in the frequency domain comprises receiving the configuration via one of: radio resource control signaling, a medium access control control element, or downlink control information.
Aspect 3: The method of any of Aspects 1 through 2, wherein the quantity of additional guard REs in the frequency domain is based at least in part on a DMRS configuration type-1 or a DMRS configuration type-2.
Aspect 4: The method of any of Aspects 1 through 3, wherein the quantity of additional guard REs in the frequency domain is based at least in part on a quantity of symbols associated with a DMRS pattern.
Aspect 5: The method of any of Aspects 1 through 4, wherein the quantity of additional guard REs in the frequency domain is based at least in part on a quantity associated with the different frequency division multiplexed DMRS CDM groups.
Aspect 6: The method of any of Aspects 1 through 5, wherein the quantity of additional guard REs in the frequency domain is based at least in part on a subcarrier spacing associated with a downlink channel or an uplink channel.
Aspect 7: The method of any of Aspects 1 through 6, wherein receiving the configuration that defines the quantity of additional guard REs in the frequency domain comprises receiving a semi-static configuration that defines the quantity of additional guard REs in the frequency domain; receiving the configuration in a scheduling downlink control information (DCI) associated with a downlink channel or an uplink channel; or receiving radio resource control signaling that indicates multiple possible configurations for quantities of additional guard REs in the frequency domain, and receive DCI that indicates a selection of one of the multiple possible configurations.
Aspect 8: The method of any of Aspects 1 through 7, further comprising: transmitting, to the base station, an indication that indicates a preferred quantity of additional guard REs in the frequency domain, wherein the configuration that defines the quantity of additional guard REs in the frequency domain is based at least in part on the indication.
Aspect 9: The method of any of Aspects 1 through 8, wherein the quantity of additional guard REs are associated with a DMRS pattern, and wherein the DMRS pattern is associated with more than one physical resource block.
Aspect 10: The method of any of Aspects 1 through 9, wherein the quantity of additional guard REs are associated with different quantities of additional guard REs between different pairs of frequency division multiplexed DMRS CDM groups.
Aspect 11: The method of any of Aspects 1 through 10, wherein DMRS REs associated with the different frequency division multiplexed DMRS CDM groups are associated with an energy per resource element (EPRE) boosting, wherein the EPRE boosting of the DMRS REs is based at least in part on a presence of the additional guard REs in the frequency domain, wherein the EPRE boosting is based at least in part on the quantity of additional guard REs per physical resource block (PRB) and per symbol used between the different frequency division multiplexed DMRS CDM groups, and wherein the quantity of additional guard REs is averaged over multiple PRBs spanning a DMRS pattern.
Aspect 12: The method of any of Aspects 1 through 11, further comprising: determining an offset on a ratio between a downlink channel energy per resource element (EPRE) and a DMRS EPRE on DMRS REs based at least in part on a presence of the additional guard REs in the frequency domain.
Aspect 13: The method of any of Aspects 1 through 12, further comprising: determining, based at least in part on the configuration, a pattern of additional guard REs in multiple time division multiplexed DMRS symbols.
Aspect 14: The method of any of Aspects 1 through 13, further comprising: determining, based at least in part on the configuration, a staggered pattern of additional guard REs in multiple time division multiplexed DMRS symbols, wherein the staggered pattern is based at least in part on a cyclic shifting of the different frequency division multiplexed DMRS CDM groups in the frequency domain.
Aspect 15: The method of Aspect 14, wherein the cyclic shifting is based at least in part on a quantity of DMRS symbols time division multiplexed within a single slot.
Aspect 16: The method of Aspect 15, wherein the different frequency division multiplexed DMRS CDM groups are associated with one of a physical downlink shared channel, a physical uplink shared channel, or a physical sidelink shared channel.
Aspect 17: The method of any of Aspects 1 through 16, further comprising: determining, based at least in part on the configuration, the quantity of additional guard REs on different time division multiplexed DMRS symbols within a single slot, wherein the quantity of additional guard REs are associated with a same quantity or different quantities on the different time division multiplexed DMRS symbols within the single slot based at least in part on one or more of: a DMRS configuration type-1 or a DMRS configuration type-2, a quantity of symbols associated with a DMRS pattern, a quantity associated with the different frequency division multiplexed DMRS CDM groups, a subcarrier spacing associated with a downlink channel or an uplink channel, or a quantity of time division multiplexed DMRS symbols within the single slot.
Aspect 18: The method of any of Aspects 1 through 17, further comprising: determining, based at least in part on the configuration, whether to map DMRS REs associated with a DMRS symbol onto a quantity of available REs, wherein the quantity of additional guard REs causes the quantity of available REs to not satisfy a threshold, wherein the DMRS REs are mapped onto the quantity of available REs with corresponding orthogonal cover codes, or wherein the DMRS REs are refrained from being mapped onto the quantity of available REs.
Aspect 19: The method of any of Aspects 1 through 18, wherein the UE and the base station are associated with an air-to-ground network.
Aspect 20: A method of wireless communication performed by a base station, comprising: transmitting, to a user equipment (UE), a configuration that defines a quantity of additional guard resource elements (REs) in a frequency domain between different frequency division multiplexed demodulation reference signal (DMRS) code division multiplexing (CDM) groups, wherein the additional guard REs in the frequency domain are not associated with signal transmissions; and transmitting, to the UE, one or more DMRS symbols, wherein the one or more DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups.
Aspect 21: The method of Aspect 20, wherein: the quantity of additional guard REs in the frequency domain is based at least in part on a quantity of symbols associated with a DMRS pattern; the quantity of additional guard REs in the frequency domain is based at least in part on a quantity associated with the different frequency division multiplexed DMRS CDM groups; or the quantity of additional guard REs in the frequency domain is based at least in part on a subcarrier spacing associated with a downlink channel or an uplink channel.
Aspect 22: The method of any of Aspects 20 through 21, further comprising: receiving, from the UE, an indication that indicates a preferred quantity of additional guard REs in the frequency domain, wherein the configuration that defines the quantity of additional guard REs in the frequency domain is based at least in part on the indication
Aspect 23: An apparatus for wireless communication at a device, comprising a processor, memory coupled with the processor; and instructions stored in the memory and executable by the processor to cause the apparatus to perform the method of one or mom of Aspects 1-19.
Aspect 24: A device for wireless communication, comprising a memory and one or more processors coupled to the memory, the one or more processors configured to perform the method of one or more of Aspects 1-19.
Aspect 25: An apparatus for wireless communication, comprising at least one means for performing the method of one or more of Aspects 1-19.
Aspect 26: A non-transitory computer-readable medium storing code for wireless communication, the code comprising instructions executable by a processor to perform the method of one or more of Aspects 1-19.
Aspect 27: A non-transitory computer-readable medium storing a set of instructions for wireless communication, the set of instructions comprising one or more instructions that, when executed by one or more processors of a device, cause the device to perform the method of one or more of Aspects 1-19.
Aspect 28: An apparatus for wireless communication at a device, comprising a processor; memory coupled with the processor; and instructions stored in the memory and executable by the processor to cause the apparatus to perform the method of one or more of Aspects 20-22.
Aspect 29: A device for wireless communication, comprising a memory and one or more processors coupled to the memory, the one or more processors configured to perform the method of one or more of Aspects 20-22.
Aspect 30: An apparatus for wireless communication, comprising at least one means for performing the method of one or more of Aspects 20-22.
Aspect 31: A non-transitory computer-readable medium storing code for wireless communication, the code comprising instructions executable by a processor to perform the method of one or more of Aspects 20-22.
Aspect 32: A non-transitory computer-readable medium storing a set of instructions for wireless communication, the set of instructions comprising one or more instructions that, when executed by one or more processors of a device, cause the device to perform the method of one or more of Aspects 20-22.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or.” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a base station, a configuration that defines a quantity of additional guard resource elements (REs) in a frequency domain between different frequency division multiplexed demodulation reference signal (DMRS) code division multiplexing (CDM) groups, wherein the additional guard REs in the frequency domain are not associated with signal transmissions; and
perform a channel estimation based at least in part on the quantity of additional guard REs in the frequency domain between the different frequency division multiplexed DMRS CDM groups.

2. The UE of claim 1, wherein the one or more processors, to receive the configuration that defines the quantity of additional guard REs in the frequency domain, are configured to receive the configuration via one of: radio resource control signaling, a medium access control control element, or downlink control information.

3. The UE of claim 1, wherein the quantity of additional guard REs in the frequency domain is based at least in part on a DMRS configuration type-1 or a DMRS configuration type-2.

4. The UE of claim 1, wherein the quantity of additional guard REs in the frequency domain is based at least in part on a quantity of symbols associated with a DMRS pattern.

5. The UE of claim 1, wherein the quantity of additional guard REs in the frequency domain is based at least in part on a quantity associated with the different frequency division multiplexed DMRS CDM groups.

6. The UE of claim 1, wherein the quantity of additional guard REs in the frequency domain is based at least in part on a subcarrier spacing associated with a downlink channel or an uplink channel.

7. The UE of claim 1, wherein the one or more processors, to receive the configuration that defines the quantity of additional guard REs in the frequency domain, are configured to:
receive a semi-static configuration that defines the quantity of additional guard REs in the frequency domain;
receive the configuration in a scheduling downlink control information (DCI) associated with a downlink channel or an uplink channel; or
receive radio resource control signaling that indicates multiple possible configurations for quantities of additional guard REs in the frequency domain, and receive DCI that indicates a selection of one of the multiple possible configurations.

8. The UE of claim 1, wherein the one or more processors are further configured to:
transmit, to the base station, an indication that indicates a preferred quantity of additional guard REs in the frequency domain, wherein the configuration that defines the quantity of additional guard REs in the frequency domain is based at least in part on the indication.

9. The UE of claim 1, wherein the quantity of additional guard REs are associated with a DMRS pattern, and wherein the DMRS pattern is associated with more than one physical resource block.

10. The UE of claim 1, wherein the quantity of additional guard REs are associated with different quantities of additional guard REs between different pairs of frequency division multiplexed DMRS CDM groups.

11. The UE of claim 1, wherein DMRS REs associated with the different frequency division multiplexed DMRS CDM groups are associated with an energy per resource element (EPRE) boosting, wherein the EPRE boosting of the DMRS REs is based at least in part on a presence of the additional guard REs in the frequency domain, wherein the EPRE boosting is based at least in part on the quantity of additional guard REs per physical resource block (PRB) and per symbol used between the different frequency division multiplexed DMRS CDM groups, and wherein the quantity of additional guard REs is averaged over multiple PRBs spanning a DMRS pattern.

12. The UE of claim 1, wherein the one or more processors are further configured to:
determine an offset on a ratio between a downlink channel energy per resource element (EPRE) and a DMRS EPRE on DMRS REs based at least in part on a presence of the additional guard REs in the frequency domain.

13. The UE of claim 1, wherein the one or more processors are further configured to:
determine, based at least in part on the configuration, a pattern of additional guard REs in multiple time division multiplexed DMRS symbols.

14. The UE of claim 1, wherein the one or more processors are further configured to:
determine, based at least in part on the configuration, a staggered pattern of additional guard REs in multiple time division multiplexed DMRS symbols, wherein the staggered pattern is based at least in part on a cyclic shifting of the different frequency division multiplexed DMRS CDM groups in the frequency domain.

15. The UE of claim 14, wherein the cyclic shifting is based at least in part on a quantity of DMRS symbols time division multiplexed within a single slot.

16. The UE of claim 1, wherein the different frequency division multiplexed DMRS CDM groups are associated with one of a physical downlink shared channel, a physical uplink shared channel, or a physical sidelink shared channel.

17. The UE of claim 1, wherein the one or more processors are further configured to:
determine, based at least in part on the configuration, the quantity of additional guard REs on different time division multiplexed DMRS symbols within a single slot, wherein the quantity of additional guard REs are associated with a same quantity or different quantities on the different time division multiplexed DMRS symbols within the single slot based at least in part on one or more of: a DMRS configuration type-1 or a DMRS configuration type-2, a quantity of symbols associated with a DMRS pattern, a quantity associated with the different frequency division multiplexed DMRS CDM groups, a subcarrier spacing associated with a downlink channel or an uplink channel, or a quantity of time division multiplexed DMRS symbols within the single slot.

18. The UE of claim 1, wherein the one or more processors are further configured to:
determine, based at least in part on the configuration, whether to map DMRS REs associated with a DMRS symbol onto a quantity of available REs, wherein the quantity of additional guard REs causes the quantity of available REs to not satisfy a threshold, wherein the DMRS REs are mapped onto the quantity of available REs with corresponding orthogonal cover codes, or wherein the DMRS REs are refrained from being mapped onto the quantity of available REs.

19. The UE of claim 1, wherein the UE and the base station are associated with an air-to-ground network.

20. A base station for wireless communication, comprising:
a memory; and
one or more processors, coupled to the memory, configured to:
transmit, to a user equipment (UE), a configuration that defines a quantity of additional guard resource elements (REs) in a frequency domain between different frequency division multiplexed demodulation reference signal (DMRS) code division multiplexing (CDM) groups, wherein the additional guard REs in the frequency domain are not associated with signal transmissions; and
transmit, to the UE, one or more DMRS symbols, wherein the one or more DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups.

21. The base station of claim 20, wherein:
the quantity of additional guard REs in the frequency domain is based at least in part on a quantity of symbols associated with a DMRS pattern;
the quantity of additional guard REs in the frequency domain is based at least in part on a quantity associated with the different frequency division multiplexed DMRS CDM groups; or
the quantity of additional guard REs in the frequency domain is based at least in part on a subcarrier spacing associated with a downlink channel or an uplink channel.

22. The base station of claim 20, wherein the one or more processors are further configured to:
receive, from the UE, an indication that indicates a preferred quantity of additional guard REs in the frequency domain, wherein the configuration that defines the quantity of additional guard REs in the frequency domain is based at least in part on the indication.

23. A method of wireless communication performed by a user equipment (UE), comprising:
receiving, from a base station, a configuration that defines a quantity of additional guard resource elements (REs) in a frequency domain between different frequency division multiplexed demodulation reference signal (DMRS) code division multiplexing (CDM) groups, wherein the additional guard REs in the frequency domain are not associated with signal transmissions; and
performing a channel estimation based at least in part on the quantity of additional guard REs in the frequency domain between the different frequency division multiplexed DMRS CDM groups.

24. The method of claim 23, wherein:
the quantity of additional guard REs in the frequency domain is based at least in part on a quantity of symbols associated with a DMRS pattern;
the quantity of additional guard REs in the frequency domain is based at least in part on a quantity associated with the different frequency division multiplexed DMRS CDM groups; or
the quantity of additional guard REs in the frequency domain is based at least in part on a subcarrier spacing associated with a downlink channel or an uplink channel.

25. The method of claim 23, wherein DMRS REs associated with the different frequency division multiplexed DMRS CDM groups are associated with an energy per resource element (EPRE) boosting, wherein the EPRE boosting of the DMRS REs is based at least in part on a presence of the additional guard REs in the frequency domain, wherein the EPRE boosting is based at least in part on the quantity of additional guard REs per physical resource block (PRB) and per symbol used between the different frequency division multiplexed DMRS CDM groups, and wherein the quantity of additional guard REs is averaged over multiple PRBs spanning a DMRS pattern.

26. The method of claim 23, further comprising:
determining an offset on a ratio between a downlink channel energy per resource element (EPRE) and a DMRS EPRE on DMRS REs based at least in part on a presence of the additional guard REs in the frequency domain;
determining, based at least in part on the configuration, a pattern of additional guard REs in multiple time division multiplexed DMRS symbols; or
determining, based at least in part on the configuration, a staggered pattern of additional guard REs in multiple time division multiplexed DMRS symbols, wherein the staggered pattern is based at least in part on a cyclic shifting of the different frequency division multiplexed DMRS CDM groups in the frequency domain, and wherein the cyclic shifting is based at least in part on a quantity of DMRS symbols time division multiplexed within a single slot.

27. The method of claim 23, further comprising:
determining, based at least in part on the configuration, the quantity of additional guard REs on different time division multiplexed DMRS symbols within a single slot, wherein the quantity of additional guard REs are associated with a same quantity or different quantities on the different time division multiplexed DMRS symbols within the single slot based at least in part on one or more of: a DMRS configuration type-1 or a DMRS configuration type-2, a quantity of symbols associated with a DMRS pattern, a quantity associated with the different frequency division multiplexed DMRS CDM groups, a subcarrier spacing associated with a downlink channel or an uplink channel, or a quantity of time division multiplexed DMRS symbols within the single slot; or
determining, based at least in part on the configuration, whether to map DMRS REs associated with a DMRS symbol onto a quantity of available REs, wherein the quantity of additional guard REs causes the quantity of available REs to not satisfy a threshold.

28. A method of wireless communication performed by a base station, comprising:
transmitting, to a user equipment (UE), a configuration that defines a quantity of additional guard resource elements (REs) in a frequency domain between different frequency division multiplexed demodulation reference signal (DMRS) code division multiplexing (CDM) groups, wherein the additional guard REs in the frequency domain are not associated with signal transmissions; and
transmitting, to the UE, one or more DMRS symbols, wherein the one or more DMRS symbols are associated with one of the different frequency division multiplexed DMRS CDM groups, and wherein a channel estimation is based at least in part on the one or more DMRS symbols and the quantity of additional guard REs in the frequency domain between the different frequency division multiplexed DMRS CDM groups.

29. The method of claim 28, wherein:
the quantity of additional guard REs in the frequency domain is based at least in part on a quantity of symbols associated with a DMRS pattern;
the quantity of additional guard REs in the frequency domain is based at least in part on a quantity associated with the different frequency division multiplexed DMRS CDM groups; or
the quantity of additional guard REs in the frequency domain is based at least in part on a subcarrier spacing associated with a downlink channel or an uplink channel.

30. The method of claim 28, further comprising:
receiving, from the UE, an indication that indicates a preferred quantity of additional guard REs in the frequency domain, wherein the configuration that defines the quantity of additional guard REs in the frequency domain is based at least in part on the indication.
